(19) United States
(12) Patent Application Publication
(10) Pub. No.: US 2018/0166794 A1
(43) Pub. Date: Jun. 14, 2018

(54) 2D-MIMO RADAR ANTENNA ARRAY GEOMETRY AND DESIGN METHOD

(71) Applicant: GM GLOBAL TECHNOLOGY OPERATIONS LLC, Detroit, MI (US)

(72) Inventors: Dani Raphaeli, Kfar Saba (IL); Igal Bilik, Rehovot (IL); Oded Bialer, Petah Tivak (IL)

(21) Appl. No.: 15/378,857

(22) Filed: Dec. 14, 2016

(51) Int. Cl. H01Q 21/24; H01Q 21/06; H01Q 1/38; G01S 13/06

(52) U.S. Cl. CPC H01Q 21/24; G01S 13/06; H01Q 1/38; H01Q 21/061

(57) ABSTRACT

A multiple input multiple output (MIMO) antenna for a radar system includes a plurality of transmitter antennas forming a planar transmitter antenna array, wherein the plurality of transmitter antennas are configured to emit orthogonal waveforms, and a plurality of receiver antennas forming at least two receiver antenna arrays, wherein along a first axis an interelement spacing between the plurality of receiver antennas in each receiver antenna array is dense relative to an interelement spacing between the plurality of transmitter antennas; and along a second axis the interelement spacing between the plurality of transmitter antennas is dense relative to the interelement spacing between the plurality of receiver antennas.

### TECHNICAL FIELD

The present invention relates generally to MIMO antenna arrays, and more particularly, to a compact MIMO antenna array arrangement that optimizes the three-dimensional spatial beam pattern while maintaining an optimal uniform virtual array.

### BACKGROUND

Advanced radar systems in use today use a multiple-input multiple-output (MIMO) concept that employs multiple antennas at the transmitter to transmit independent (orthogonal) waveforms and multiple antennas at the receiver to receive the radar echoes. In a “collocated” MIMO radar configuration, the antennas in both the transmitter and the receiver are spaced sufficiently close so that each antenna views the same aspect of an object such that a point target is assumed. In the MIMO receiver, a matched filter bank is used to extract the orthogonal waveform components. When the orthogonal signals are transmitted from different antennas, the echoes of each signal carry independent information about detected objects and the different propagation paths. Phase differences caused by different transmitting antennas along with phase differences caused by different receiving antennas mathematically form a virtual antenna array that provides for a larger virtual aperture using fewer antenna elements. Conceptually, the virtual array is created by interleaving between each of the transmitter Tₓ and receiver Rₓ antenna elements such that the elements in the virtual array represent Tₓ-Rₓ pairs for each of the transmitter Tₓ and receiver Rₓ antennas in the MIMO array. For collocated MIMO antennas, a transmit array having N_{Tx} transmitter antennas and a receive array having N_{Rx} receiver antennas produces a virtual array having N_{Tx}N_{Rx} virtual receiver elements. In other words, the orthogonal waveforms are be extracted by the matched filters at the receiver such that there are a total of N_{Tx}N_{Rx} extracted signals in the virtual array.

Many MIMO radar systems, and in particular those used for automotive applications, are optimized to determine distance and a horizontal or azimuth angle to a target or object, but are limited with respect to detecting objects in the elevation. The spatial capability of radars in azimuth and elevation are influenced by the number of transmit and receive antennas, which also drives system cost. In other words, high angular resolution in general requires a large aperture with a large number of antenna elements, which increases the cost of the antenna. Therefore, in applications that are sensitive to cost factors, the number of transmit and receive antennas is generally held to a minimum.

FIG. 1a illustrates a known MIMO antenna configuration 10 having a uniformly spaced receiver antenna array 12 extending linearly along a horizontal axis and two parallel transmit antenna arrays 14 extending along a vertical axis. The receiver antenna array 12 includes N_{Rx} receiver antennas Rₓ uniformly spaced apart by a distance d_{R}, and the two transmit antenna arrays 14 that include N_{Tx} transmitter antennas Tₓ, wherein the transmitter antennas Tₓ are spaced apart by a distance d_{T} in the horizontal and vertical axes. In this particular example, the number of receiver antennas N_{R}, and the number of transmitter antennas N_{T} are both equal to 16, the distance d_{R} between the receiver antennas Rₓ is 0.5λ, and the distance d_{T} between the transmit antenna arrays 14 is N_{Rx}d_{R}. The distance d_{T} between the transmitter antennas Tₓ is chosen to be N_{Rx}d_{R} so that the resulting virtual array 16 has uniformly spaced elements at a distance d_{R}. As shown in FIG. 1b, the uniform virtual array 16 having N_{Tx}N_{Rx} virtual antenna elements 18 resulting from the antenna array 10 produces a large virtual aperture providing a high angular resolution in both dimensions and has a uniform spacing in the horizontal axis and vertical axis. However, because the vertical axis spacing d_{T} between the transmitter antennas Tₓ is much larger than 0.5λ, ambiguities arise due to grating lobes in elevation, and thus, the 3-dimensional spatial beam pattern of the virtual array 16 produced by the known antenna configuration 10 is not optimal with respect to the elevation domain. Furthermore, it can be seen that the antenna configuration 10 in FIG. 1a is not compact so there is a large waste of area on the mounting surface. It is also advantageous for cost saving to manufacture the MIMO antenna arrays on a standard printed circuit board (PCB), and to fit the integrated circuits (IC) that feed or are to be fed by the antenna on the same board. Due to the lack of compactness, the known antenna configuration 10 in FIG. 1a cannot be manufactured on a PCB.

### SUMMARY

According to an embodiment of the invention, there is provided a multiple input multiple output (MIMO) antenna for a radar system that includes a plurality of transmitter antennas forming a planar transmitter antenna array, wherein the plurality of transmitter antennas are configured to emit orthogonal waveforms. The MIMO antenna further includes a plurality of receiver antennas forming at least two receiver antenna arrays, wherein along a first axis an interelement spacing between the plurality of receiver antennas in each receiver antenna array is dense relative to an interelement spacing between the plurality of transmitter antennas; and along a second axis the interelement spacing between the plurality of transmitter antennas is dense relative to the interelement spacing between the plurality of receiver antennas.

According to another embodiment of the invention, there is provided a multiple input multiple output (MIMO) antenna for a radar system that includes a planar transmitter antenna array having a first portion and a second portion, wherein the first portion includes a first plurality of transmitter antennas forming a plurality of equidistant rows extending along a first axis and a plurality of equidistant columns extending along a second axis, and wherein the second portion includes a second plurality of transmitter antennas forming a row extending along the first axis, wherein the first portion is separated from the second portion along the second axis by an offset relative to a spacing of the equidistant rows in the first portion. The MIMO antenna further includes a plurality of receiver antennas forming at least two receiver antenna arrays, wherein an interelement spacing between the plurality of receiver antennas in each receiver antenna array is uniform along the first axis, and wherein the at least two receiver antenna arrays are separated along the second axis by a distance proportional to a number of rows in the first portion and the spacing of the equidistant rows in the first portion.

According to yet another embodiment of the invention, there is provided a method for determining an angle of arrival of an incident plane wave using a multiple input multiple output (MIMO) antenna array configured to produce a virtual array having multiple overlapping virtual antenna elements. The method includes receiving a plurality of incident signals reflected from one or more objects, obtaining magnitudes from the plurality of incident signals for at least two of the overlapping virtual antenna elements at a select elevation, calculating a phase for incident signals received from the at least two overlapping virtual antenna elements, wherein the phase is based on an expected phase difference associated with the overlapping virtual antenna elements, and determining the angle of arrival by applying a resolving function to compare the expected phase difference between the signals from two of the overlapping virtual antenna elements.

### BRIEF DESCRIPTION OF THE DRAWINGS

One or more embodiments of the invention will hereinafter be described in conjunction with the appended drawings, wherein like designations denote like elements, and wherein:

FIG. 1a illustrates a known configuration for a MIMO antenna array;

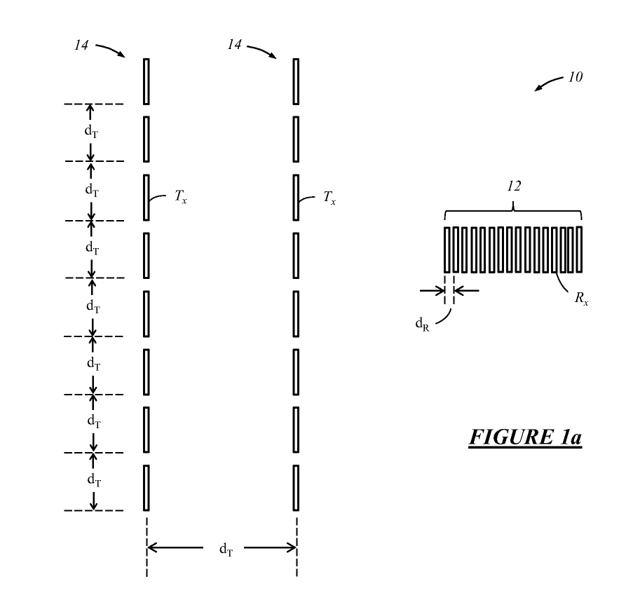

FIG. 1b illustrates a virtual antenna array resulting from the known MIMO antenna array shown in FIG. 1a;

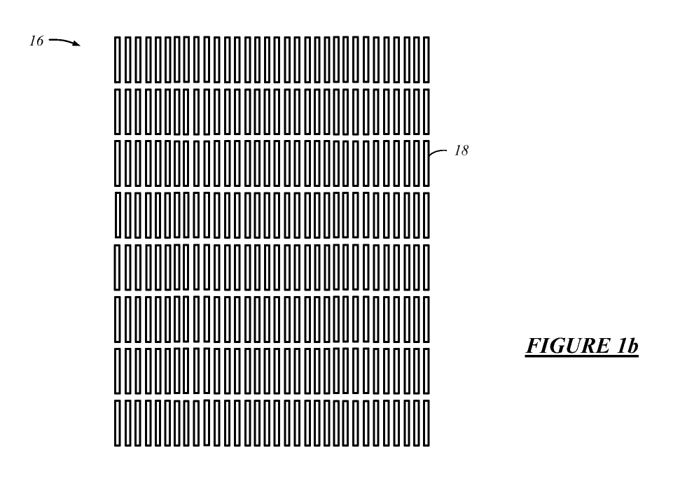

FIG. 2 illustrates an exemplary MIMO antenna array according to an embodiment of the present invention;

FIG. 3 illustrates another exemplary MIMO antenna array according to an embodiment of the present invention;

FIG. 4 illustrates a virtual array formed by the MIMO antenna array of FIG. 3; and

FIG. 5 illustrates a flow chart depicting a method according to an embodiment of the invention for resolving ambiguities relating to the elevation domain.

### DETAILED DESCRIPTION OF THE ILLUSTRATED EMBODIMENT(S)

The system and method described below are directed to a compact MIMO antenna array arrangement that optimizes spatial resolution while maintaining an optimal uniform virtual array. In one embodiment, the array includes a plurality of transmitter antennas configured as a planar array, and a plurality of receiver antennas arranged into multiple linear arrays. The arrangement of the transmitter and receiver antennas is sufficiently compact such that the array is suitable for manufacture on a standard printed circuit board. The planar transmitter array and the linear receiver arrays are selectively arranged such that the MIMO operation is mixed in the azimuth and elevation domains. In addition, the arrangement of the transmitter and receiver antennas allows for the integrated circuits associated with the antennas to be located proximate to each of the antenna elements on the same printed circuit board.

To address angular ambiguities associated with grating lobes that occur in the elevation domain, a subset of the plurality of transmitter antennas is dedicated to resolving ambiguities. The subset of transmitter antennas is positioned at an offset from the other transmitter antennas such that the offset generates an element overlap in the virtual array response. This overlap of elements in the virtual array is used to resolve the ambiguities in the angle of arrival of an incident signal.

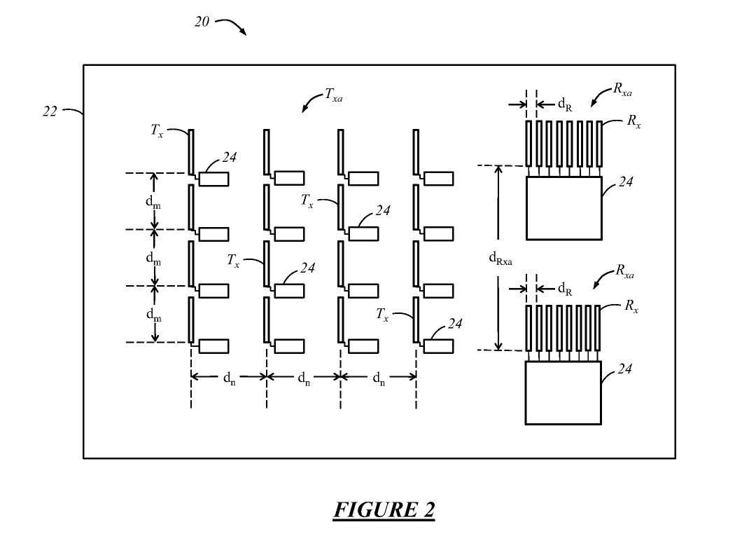

FIG. 2 illustrates an exemplary MIMO antenna array 20 according to at least one embodiment of the present invention. The antenna array 20 is arranged on a surface 22 having reference axes in the horizontal (azimuth) and vertical (elevation) directions. In one embodiment, the surface 22 is a printed circuit board that mechanically supports and electrically connects electronic components of the antenna array 20 using conductive tracks, pads, and other features etched from copper sheets laminated onto a non-conductive substrate. The printed circuit boards can be single sided, double sided, or multi-layer. Conductors on different layers may be connected with plated-through holes called vias. The electronic components may be printed onto the printed circuit board and/or may contain components embedded in the substrate.

Referring to FIG. 2, the antenna array 20 includes a plurality of transmitter antenna elements Tₓ and a plurality of receiver antennas Rₓ, wherein N_{Tx} is the number of transmitter antenna elements Tₓ, and N_{Rx} is the number of receiver antenna elements Rₓ. As understood by those skilled in the art, the shape of the antenna element influences the antenna response. Consistent with automotive applications, the antenna elements in the illustrated embodiment are narrow in the horizontal axis and long in the vertical axis, which generates a narrow radiation angle in the vertical axis and a wide angle in the horizontal axis. However, the shape of the antenna elements in the illustrated embodiment is merely exemplary and non-limiting. One of ordinary skill in the art appreciates that the array configuration disclosed herein may be applicable to any suitably shaped antenna element. Moreover, the number of transmitter and receiver antenna elements in each of the exemplary arrays presented herein is merely exemplary and may vary depending on the application.

The plurality of receiver antennas Rₓ are divided into multiple linear receiver arrays Rₓₐ separated in the vertical axis by a distance d_{Rxa}, which as discussed in further detail below, is relative to the configuration of the transmitter antenna elements Tₓ. The receiver antenna elements Rₓ in each of the receiver arrays Rₓₐ are separated by a distance d_{R}, which in one embodiment is uniform and equal to 0.5λ to maintain a uniform and unambiguous beam pattern in the azimuth domain. In the non-limiting example shown in FIG. 2, the number N_{Tx} of transmitter antenna elements Tₓ is equal to 16 and the number N_{Rx} of receiver antenna elements Rₓ is equal to 16.

The plurality of transmitter antenna elements Tₓ are arranged as a planar transmit array Tₓₐ having MₜNₜ transmitter antennas Tₓ, where Mₜ is the number of transmitter antenna elements in each column and Nₜ is the number of transmitter antenna elements in each row. In one embodiment, the adjacent transmitter antennas Tₓ in any given column of the transmit array Tₓₐ are equidistant with interelement spacing dₘ in the vertical axis, and in any given row are equidistant with interelement spacing dₙ in the horizontal axis. In one embodiment, the interelement spacing dₘ=dₙ=d_{R}N_{Rx} to maintain uniform spacing in the virtual array. While the spacing dₘ and dₙ between phase centers of the transmitter antennas Tₓ is the same in the horizontal and vertical axes, due to the geometry of the antenna elements, the physical spacing between the transmitter antenna elements Tₓ in the horizontal and vertical axes appears different. In other words, the physical distance between the transmitter antenna elements Tₓ in each row along the horizontal axis appears wider relative to the physical spacing between the transmitter antenna elements Tₓ in each column along the vertical axis.

With continued reference to FIG. 2, the plurality of receiver antennas Rₓ are configured as linear receiver arrays Rₓₐ wherein each adjacent receiver antenna element Rₓ has equidistant interelement spacing d_{R}. In one embodiment, the plurality of receiver antennas Rₓ are divided into two linear receiver arrays Rₓₐ each having eight receiver antennas Rₓ and are separated by distance d_{Rxa} in the vertical axis. The distance d_{Rxa} between the receiver arrays Rₓₐ is proportional to the size and configuration of the planar transmit array 24. In one embodiment, d_{Rxa}=Mₜ dₘ=Mₜ dₙ, where Mₜ is the number of transmitter antenna elements in each column of the transmit array Tₓₐ, dₘ is the interelement spacing between adjacent transmitter antennas Tₓ in any given column of the transmit array Tₓₐ, and dₙ is the interelement spacing between adjacent transmitter antennas Tₓ in any given row of the transmit array Tₓₐ. As understood by one of ordinary skill in the art, the number of linear receiver arrays may vary depending on the number of transmitter and receiver antennas, the size of the overall antenna array, the size of the mounting surface, and/or the MIMO antenna array performance metrics.

The planar transmit array Tₓₐ and the linear receiver arrays Rₓₐ of antenna array 20 are selectively arranged such that the MIMO operation is mixed between the azimuth and elevation domains. In other words, the planar transmit array Tₓₐ and the linear receiver arrays Rₓₐ are arranged such that the density of the interelement spacing in each of the respective arrays Tₓₐ, Rₓₐ is mixed with respect to both the horizontal and vertical apertures of the antenna array 20. For example, from the perspective of the horizontal aperture of the antenna array 20, the interelement spacing between the transmitter antenna elements Tₓ in the planar transmit array Tₓₐ is relatively sparse (i.e., widely-spaced) compared to the relatively dense interelement spacing between the receiver antenna elements Rₓ in the linear receiver arrays Rₓₐ. Conversely, from the perspective of the vertical aperture of the antenna array 20, the interelement spacing between the transmitter antenna elements Tₓ in the planar transmit array Tₓₐ is relatively dense compared to the relatively sparse spacing between the linear receiver arrays Rₓₐ. Stated another way, in the horizontal aperture, dₙ>d_{R}, wherein dₙ is the interelement spacing between adjacent transmitter antennas Tₓ in the horizontal axis and d_{R} is the distance between receiver antenna elements Rₓ in each of the receiver arrays Rₓₐ. In the vertical aperture, dₘ<d_{Rxa}, wherein dₘ is the interelement spacing between adjacent transmitter antennas Tₓ in the vertical axis and d_{Rxa} is the interelement spacing between the receiver antenna elements Rₓ in the linear receiver arrays Rₓₐ in the vertical axis.

Using the principles of operation with respect to MIMO, the resulting virtual array formed by antenna array 20 is a 256 element (N_{Tx}N_{Rx}) receiver array having 32 uniformly spaced elements in the azimuth and 8 uniformly spaced elements in the elevation. As understood by those skilled in the art, due to the operation of a MIMO antenna array, the number of virtual receiver antennas in the horizontal aperture of the virtual array formed by a collocated MIMO antenna array is equal to N_{Txh}N_{Rxh}, where N_{Txh} is the number of transmitter antenna elements Tₓ positioned along the horizontal axis of the antenna array 20 and N_{Rxh} is the number of receiver antenna elements Rₓ positioned along the horizontal axis of the antenna array 20. Similarly, the number of virtual receiver antennas in the vertical aperture is equal to N_{Txv}N_{Rxv}, where N_{Txv} is the number of transmitter antenna elements Tₓ positioned along the vertical axis of the antenna array 20 and N_{Rxv} is the number of receiver antenna elements Rₓ positioned along the vertical axis of the antenna array 20. Moreover, it is known that the MIMO virtual array positions are a convolution of traditional transmit and receive array element positions.

In an alternative embodiment, the antenna array 20 may be arranged in an opposite manner such that the transmitter elements Tₓ are arranged with dense spacing in the horizontal axis and more widely spaced in the vertical axis, and the receiver antenna elements Rₓ being sparsely separated in the horizontal axis and densely spaced in the vertical axis.

The arrangement of the antenna array 20 further includes one or more electronic devices 24 associated with the plurality of transmitter and receiver antenna elements Tₓ, Rₓ. The electronic devices 24 may include without limitation, components and/or devices that comprise transmitter and receiver circuitry such as, for example, power dividers, amplifiers, converters, filters, etc. as known in the art. In the embodiment shown in FIG. 2, the electronic devices 34 are integrated circuits arranged on the surface 22 of the printed circuit board located proximate to each of the transmitter and receiver antennas Tₓ, Rₓ.

The MIMO antenna array 20 in FIG. 2 is configured as a compact antenna array arrangement suitable for fabrication on a standard printed circuit board. The arrangement of antenna elements in the antenna array 20 maximizes the utilization of the available surface area on the printed circuit board and produces an optimal 3-dimensional spatial beam pattern. Moreover, the resulting virtual array has large virtual aperture providing a high angular resolution in both the azimuth and elevation domains. However, given the spacing between the transmitter antenna elements Tₓ used to maintain a uniform virtual array (i.e., dₘ=dₙ=d_{R}N_{Rx}), the distance dₘ between the transmitter antenna elements Tₓ in the vertical axis is generally much greater than 0.5λ. Consequently, the virtual array formed by antenna array 20 exhibits ambiguity in the elevation domain caused by grating lobes. These ambiguities are addressed by a modified version of antenna array 20 as described below.

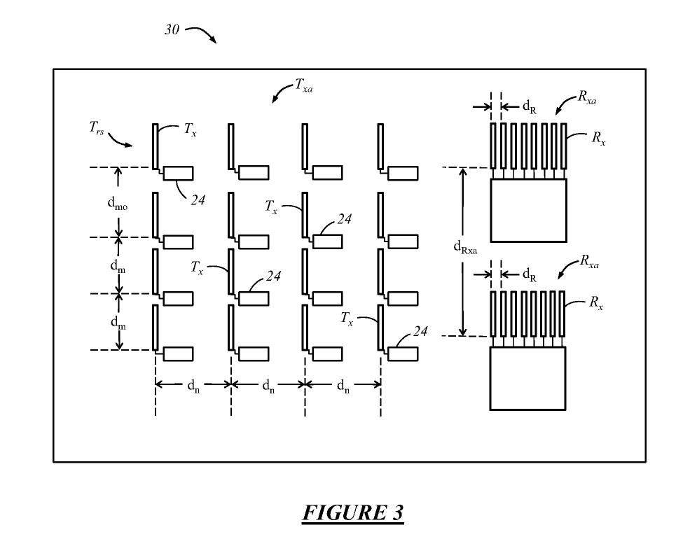

FIG. 3 illustrates another exemplary MIMO antenna array 30 according to an embodiment of the present invention. Similar to antenna array 20 in FIG. 2, the antenna array 30 includes a plurality of transmitter antenna elements Tₓ arranged as a planar transmit array Tₓₐ, and a plurality of receiver antennas Rₓ divided into two linear receiver arrays Rₓₐ separated by distance d_{Rxa} in the vertical axis. The distance d_{Rxa}=Mₜdₘ, where Mₜ is the number of transmitter antenna elements in each column of the transmit array Tₓₐ and dₘ is the interelement spacing between adjacent transmitter antennas Tₓ in any given column of the transmit array Tₓₐ. Each adjacent receiver antennas Rₓ has equidistant interelement spacing d_{R}, which in one embodiment is 0.5λ to maintain an unambiguous beam pattern in the azimuth.

The arrangement of the antenna array 30 further includes one or more electronic devices 24 associated with the transmitter and receiver antennas Tₓ, Rₓ. The electronic devices 24 may include without limitation, components and/or devices that comprise transmitter and receiver circuitry such as, for example, power dividers, amplifiers, converters, filters, etc. as known in the art. In the embodiment shown in FIG. 3, the electronic devices 24 are integrated circuits arranged on the surface 22 of the printed circuit board located proximate to each of the transmitter and receiver antennas Tₓ, Rₓ.

The antenna array 30 maintains the compact arrangement described with respect to antenna array 20 in FIG. 2. In particular, the planar transmit array Tₓₐ, and the linear receiver arrays Rₓₐ are arranged such that the MIMO operation is mixed between the azimuth and elevation domains, as explained above with respect to antenna array 20. In addition, the adjacent transmitter antennas Tₓ in any given column of the transmit array Tₓₐ are equidistant with interelement spacing dₙ in the horizontal axis, wherein dₙ=d_{R}N_{Rx} to maintain uniform spacing in the horizontal virtual aperture. However, while the overall number N_{Tx} of transmitter antenna elements Tₓ in antenna array 30 remains the same as in antenna array 20, the arrangement of the transmitter antenna elements Tₓ in the antenna array 30 is modified as described below to facilitate resolution of the angular ambiguities in the elevation domain.

Consistent with the antenna array 20 in FIG. 2, the planar transmit array Tₓₐ of the antenna array 30 includes MₜNₜ transmitter antennas Tₓ, where Mₜ is the number of transmitter antenna elements in each column and Nₜ is the number of transmitter antenna elements in each row. However, to address the angular ambiguities created in the elevation domain, one row Tᵣₛ of transmitter antenna elements Tₓ is shifted in the vertical axis by an offset dₒ relative to the uniform interelement spacing dₘ between the adjacent transmitter antennas Tₓ in any given column of the transmit array Tₓₐ. In other words, the distance dₘ between the shifted row Tᵣₛ of transmitter antenna elements Tₓ and the adjacent row in transmit array Tₓₐ is equal to interelement spacing dₘ+the offset dₒ. In one embodiment, the offset dₒ by which the row Tᵣₛ of transmitter antenna elements Tₓ is shifted is equal to pλ, wherein p is a shifting factor and λ is the wavelength of the transmitted signal. The shifting factor p is determined empirically based on electromagnetic simulation to provide the best compromise between the level of grating lobes and the ability to resolve ambiguity in elevation. Interelement spacing dₘ between the remaining rows in transmit array Tₓₐ remains equal to d_{R}N_{Rx}. In the non-limiting embodiment shown in FIG. 3, the shifted row Tᵣₛ is the top row of the transmit array Tₓₐ. Shifting the row Tᵣₛ of transmitter antenna elements Tₓ creates an overlap in the vertical aperture of the virtual array formed by the antenna array 30. As set forth in detail below, this overlap is used to resolve ambiguities in the elevation domain.

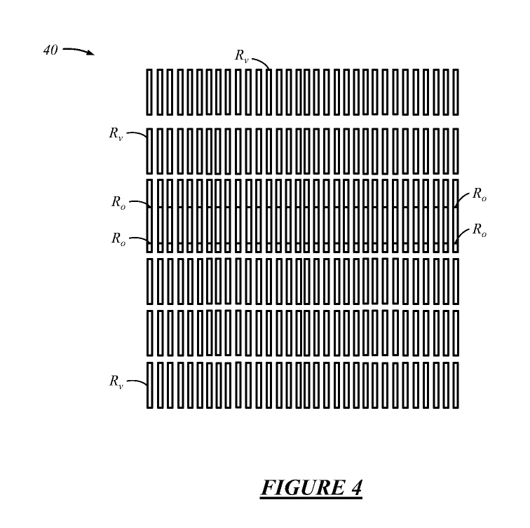

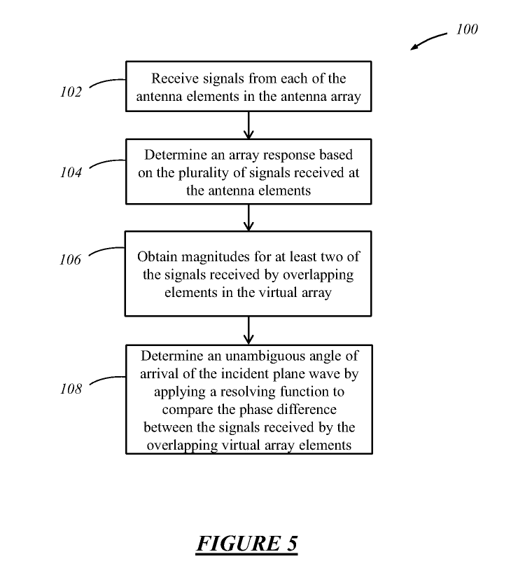

FIG. 4 illustrates a virtual array 40 formed by the antenna array 30 shown in FIG. 3 according to known methods. Conventionally, for an antenna array 30 with N_{Tx} transmitter antenna elements Tₓ and N_{Rx} receiver antenna elements Rₓ, the maximum number of virtual elements Rᵥ is equal to the product of the number of transmitter and receiver antennas (i.e., N_{Tx}N_{Rx}). However, due to array redundancy, when two virtual elements from the collinear Tₓ-Rₓ pairs overlap spatially within the resulting two-dimensional virtual aperture, the total number of virtual elements is effectively less than N_{Tx}N_{Rx}, The offset dₒ by which the row Tᵣₛ of transmitter antenna elements Tₓ is shifted in antenna array 30 produces this redundancy and creates an overlap Rₒ of elements in the elevation domain. As such, the number Nᵥₘ of virtual elements in the virtual array 40 is effectively 192 rather than 256 for the virtual array produced by antenna array 20 in FIG. 2. The geometry of the virtual array 40 has also changed in that there are now 32 uniformly spaced elements in the azimuth, but only 6 undistinguishable virtual elements in the elevation. In essence, rather than having a 4×4 (Mₜ×Nₜ) planar transmit array Tₓₐ as in antenna array 20, the planar transmit array Tₓₐ in antenna array 30 is effectively reduced in the MIMO operation to a 3×4 array, wherein the number Mₜ of transmitter antenna elements in each column is 3 and the number Nₜ of transmitter antenna elements in each row is 4. Consequently, the signals received by the overlapping elements are indistinguishable from one another. This overlap is used to resolve ambiguities in the elevation domain as described in FIG. 5.

The reduction of effective elements in the transmit array Tₓₐ due to offset dₒ also effects the distance d_{Rxa} between the linear receiver arrays Rₓₐ. While the relationship remains the same (i.e., d_{Rxa}=Mₜ dₘ), the value of the distance decreases as the number Mₜ of transmitter antenna elements Tₓ in each column of the transmit array Tₓₐ is reduced.

FIG. 5 illustrates an exemplary method 100 for determining an angle of arrival for an incident signal and for resolving ambiguities associated the antenna array 40 shown in FIG. 3. As understood by those skilled in the art, the direction of an incident plane wave to an antenna array (i.e., the angle of arrival θ) can be determined based on the points at which maximums occur in an antenna array response. For example, in an antenna array with no ambiguity, a single maximum occurs in terms of magnitude in an antenna's radiation pattern in the direction (i.e. angle) in which the bulk of the radiated power travels (i.e, the main beam lobe). In this case, the angle of arrival θ of an incident plane wave can determined when the phase difference Ψ between the signals received by adjacent antenna elements is set equal to zero. In one embodiment, the phase difference Ψ can be expressed as 2πd/λ(sin θ), where the arrival angle θ is referenced off broadside (an axis perpendicular to the plane of the array) and ranges in angle from π/2 to −π/2 (90° to −90°), d is the distance between each antenna element, and λ is the wavelength of the signal. However, ambiguities arise when there are multiple maximums that occur in an array response. These additional maximums, referred to as grating lobes, result from radiation in unintended directions and are identical, or nearly identical, in magnitude to the main beam lobes. Because each of these maximums corresponds to a different angle of arrival, the radar system is not capable of distinguishing between the angle of arrival corresponding to the main lobe and the angles of arrival corresponding to the grating lobes.

Referring to FIG. 5, the disclosed method 100 assumes that the angle of arrival of the incident signal in the azimuth domain is unambiguous and is obtained separately. Thus, the method 100 is described herein only with respect to resolving the ambiguity and determining the angle of arrival of the incident signal in the elevation domain. The method 100 begins at step 102 by receiving a plurality of incident signals reflected from an object in space. The plurality of incident signals is received by the antenna array 40, and in particular, by the plurality of receiver antennas R_{Tx}. At step 104, an array response is determined according to known techniques based on the plurality of incident signals impinging the plurality of receiver antennas 26. In one embodiment, the array response of the antenna array 30 (not shown), wherein d_{R}=0.5λ, N_{Tx}=16, and λ=4 mm, produces an ambiguity in the angle of arrival θ about every 16° due to the interelement spacing dₙ being equal to 4λ (i.e., d_{R}N_{Rx}).

At step 106, values Z1 and Z2 for two received signal magnitudes are obtained at a certain azimuth from two of the overlapping receiver antennas Rₒ in virtual array 40. Based on Z1 and Z2 there are several possible angle solutions for each assumed elevation (i.e., angle of arrival) due to the array ambiguity.

At step 108, a resolving function R is used to resolve the ambiguities in the elevation. In one embodiment, the resolving function R=10 log(|(z1−z2*exp(−jψ))/(z1+z2*exp(−jψ))|), wherein ψ=2πp sin(θ) is the expected phase difference between two overlapping receiver antennas Rₒ in virtual array 40 due to the offset dₒ, and wherein p is the shifting factor. The resolving function R operates to compare the relative phase shift between signals Z1 and Z2. More specifically, in this particular example, the phase shift of Z2 is taken relative to Z1. Alternatively, the phase shift of Z1 can be taken relative to Z2 as it is only the relative phase shift that is being considered.

The correct angle of arrival θ is determined when the phases of Z1 and Z2 are equal indicating no phase shift between Z1 and Z2. In all other comparisons between the overlapped antenna elements, the phases of the received signals will be different. Stated another way, if the resolving function R was to be graphed and set to zero to represent no phase shift, then the resolving function R=−∞dB. One of ordinary skill in the art appreciates that other functions can be used that compare the phase of Z 1 and Z2*exp(−jψ). More specifically, one of ordinary skill in the art appreciates that the angular resolution function recited above is merely exemplary and that the angular resolution equation, the variables of the equation, and relationship between those variables may vary depending on the geometry of the antenna array and other application specific criteria. The shifting factor p being equal to 0.8 in this example is a result of optimization of this function with respect to the depth and the width of the null. A larger shifting factor p would result in a sharper null with a less attenuation in its depth and vice versa.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A multiple input multiple output (MIMO) antenna for a radar system, the antenna comprising:
a plurality of transmitter antennas forming a planar transmitter antenna array, wherein the plurality of transmitter antennas are configured to emit orthogonal waveforms; and
a plurality of receiver antennas forming at least two receiver antenna arrays;
wherein along a first axis an interelement spacing between the plurality of receiver antennas in each receiver antenna array is dense relative to an interelement spacing between the plurality of transmitter antennas; and along a second axis the interelement spacing between the plurality of transmitter antennas is dense relative to the interelement spacing between the plurality of receiver antennas.

2. The MIMO antenna of claim 1, wherein the first axis is a horizontal axis and the second axis is a vertical axis.

3. The MIMO antenna of claim 1, wherein the first axis is a vertical axis and the second axis is a horizontal axis.

4. The MIMO antenna of claim 1, wherein the interelement spacing between the plurality of transmitter antennas is uniform along the first and second axis, and the interelement spacing between the plurality of receiver antennas in each receiver antenna array is uniform along the first axis.

5. The MIMO antenna of claim 1, wherein the interelement spacing between the plurality of transmitter antennas is equal to the interelement spacing between the plurality of receiver antennas in each receiver antenna array times a number of receiver antennas in each receiver antenna array.

6. The MIMO antenna of claim 1, wherein the at least two receiver antenna arrays are separated along the second axis by a distance proportional to a number of transmitter antennas in each column of the planar transmitter antenna array and the interelement spacing between the plurality of transmitter antennas along the second axis.

7. The MIMO antenna of claim 1, wherein the planar transmitter antenna array and the at least two receiver antenna arrays are fabricated on a printed circuit board.

8. The MIMO antenna of claim 7, wherein the planar transmitter antenna array and the at least two receiver antenna arrays are selectively arranged to maximize surface area utilization of the printed circuit board.

9. The MIMO antenna of claim 1, further including one or more electronic devices associated with, and located proximate to, the plurality of transmitter and receiver antennas.

10. The MIMO antenna of claim 1, wherein the planar transmitter antenna array has a plurality of equidistant rows and a plurality of equidistant columns, and wherein one row of the plurality of rows is shifted from the other remaining plurality of equidistant rows in the planar transmitter antenna array along the second axis by an offset.

11. The MIMO antenna of claim 10, wherein a spacing between the remaining plurality of equidistant rows in the planar transmitter antenna array along the second axis is equal to the interelement spacing between the plurality of receiver antennas in each receiver antenna array times a number of receiver antennas in each receiver antenna array.

12. The MIMO antenna of claim 11, wherein the at least two receiver antenna arrays are separated along the second axis by a distance proportional to a number of remaining plurality of equidistant rows in the planar transmitter antenna array and the spacing between the remaining plurality of equidistant rows in the planar transmitter antenna array.

13. The MIMO antenna of claim 10, wherein the planar transmitter antenna array and the at least two receiver antenna arrays are configured to form a two-dimensional virtual receiver array, wherein the offset in the shifted row creates an overlap of one or more virtual receiver elements in each column of the virtual array.

14. The MIMO antenna of claim 10, wherein the offset is equal to a shifting factor times the wavelength of the signal transmitted by the plurality of transmitter antennas.

15. The MIMO antenna of claim 14, wherein a distance between the shifted row and an adjacent row in the remaining plurality of equidistant rows in the planar transmitter antenna array is equal to the offset plus the spacing between the remaining plurality of equidistant rows in the planar transmitter antenna array.

16. A multiple input multiple output (MIMO) antenna for a radar system, the antenna comprising:
a planar transmitter antenna array having a first portion and a second portion, wherein the first portion includes a first plurality of transmitter antennas forming a plurality of equidistant rows extending along a first axis and a plurality of equidistant columns extending along a second axis, and wherein the second portion includes a second plurality of transmitter antennas forming a row extending along the first axis, wherein the first portion is separated from the second portion along the second axis by an offset relative to a spacing of the equidistant rows in the first portion; and
a plurality of receiver antennas forming at least two receiver antenna arrays, wherein an interelement spacing between the plurality of receiver antennas in each receiver antenna array is uniform along the first axis, and wherein the at least two receiver antenna arrays are separated along the second axis by a distance proportional to a number of rows in the first portion and the spacing of the equidistant rows in the first portion.

17. The MIMO antenna of claim 16, wherein along the first axis the interelement spacing between the plurality of receiver antennas in each receiver antenna array is dense relative to a spacing between columns formed by the first and second portions of the planar transmitter antenna array; and along a second axis a relative spacing between rows of the planar transmitter antenna array is dense relative to the distance between the at least two receiver antenna arrays.

18. The MIMO antenna of claim 16, wherein the planar transmitter antenna array and the at least two receiver antenna arrays are fabricated on a printed circuit board, and wherein the planar transmitter antenna array and the at least two receiver antenna arrays are selectively arranged to maximize surface area utilization of the printed circuit board.

19. A method for determining an angle of arrival of an incident plane wave using a multiple input multiple output (MIMO) antenna array configured to produce a virtual array having multiple overlapping virtual antenna elements, the method comprising the steps of:
receiving a plurality of incident signals reflected from one or more objects;
obtaining magnitudes from the plurality of incident signals for at least two of the overlapping virtual antenna elements at a select elevation;
calculating a phase for incident signals received from the at least two overlapping virtual antenna elements, wherein the phase is based on an expected phase difference associated with the overlapping virtual antenna elements; and
determining the angle of arrival by applying a resolving function to compare the expected phase difference between the signals from two of the overlapping virtual antenna elements.

20. The method of claim 19, wherein the expected phase difference associated with the overlapping virtual antenna elements is due to a predetermined offset relative to an interelement spacing between transmitter antenna elements in the MIMO antenna array.
